(19) United States
(12) Patent Application Publication
(10) Pub. No.: US 2025/0306832 A1
(43) Pub. Date: Oct. 2, 2025

(54) DISPLAY METHOD AND ELECTRONIC DEVICE

(71) Applicant: Lenovo (Beijing) Limited, Beijing (CN)

(72) Inventors: Jing LI, Beijing (CN); Liang ZHANG, Beijing (CN)

(21) Appl. No.: 19/078,902

(22) Filed: Mar. 13, 2025

(30) Foreign Application Priority Data
Mar. 26, 2024 (CN) 202410353920.5

(51) Int. Cl. G06F 3/14; G06F 3/0484

(52) U.S. Cl. CPC G06F 3/14; G06F 3/0484

(57) ABSTRACT

A display method includes in response to an instruction to display a target image, obtaining a first display parameter of the target image, and in response to the first display parameter and a first size parameter of a target display area satisfying a predetermined condition, displaying the target image in the target display area with the first display parameter, and displaying other images in a blank area of the target display area. The first display parameter is a maximum display parameter of the target image when the target image is limited by the first size parameter of the target display area. The blank area is an area that is not occupied by the target image when the target image is displayed in the target display area with the first display parameter.

### CROSS-REFERENCE TO RELATED APPLICATION

The present disclosure claims priority to Chinese Patent Application No. 202410353920.5, filed on Mar. 26, 2024, the entire content of which is incorporated herein by reference.

### TECHNICAL FIELD

The present disclosure is related to the display technology field and, more particularly, to a display method and an electronic device.

### BACKGROUND

With the development of related technologies, to meet user viewing requirements, the screen sizes of electronic devices such as smartphones and tablets are gradually increasing. However, in the traditional display method, a content displayed on a screen at the same time is relatively monotonous. The mismatching between a displayed image and a display area size causes a large portion of the display area of the display screen being unutilized, which leads to a waste of display resources.

### SUMMARY

An aspect of the present disclosure provides a display method. The method includes in response to an instruction to display a target image, obtaining a first display parameter of the target image, and in response to the first display parameter and a first size parameter of a target display area satisfying a predetermined condition, displaying the target image in the target display area with the first display parameter, and displaying other images in a blank area of the target display area. The first display parameter is a maximum display parameter of the target image when the target image is limited by the first size parameter of the target display area. The blank area is an area that is not occupied by the target image when the target image is displayed in the target display area with the first display parameter. The predetermined condition indicates that a proportion of the blank area in the target display area is greater than a predetermined ratio. The other images are different from the target image.

An aspect of the present disclosure provides an electronic device, including a display screen, one or more processors, and one or more memories. The display screen is configured to display an image. The one or more memories store a computer program that, when executed by the one or more processors, causes the one or more processors to, in response to an instruction to display a target image, obtain a first display parameter of the target image, and in response to the first display parameter and a first size parameter of a target display area satisfy a predetermined condition, display the target image in the target display area with the first display parameter, and display one other image in a blank area of the target display area. The first display parameter is a maximum display parameter of the target image when the target image is limited by the first size parameter of the target display area. The blank area is an area that is not occupied by the target image when the target image is displayed in the target display area with the first display parameter. The predetermined condition indicates that a proportion of the blank area in the target display area is greater than a predetermined ratio. The other images are different from the target image.

### BRIEF DESCRIPTION OF THE DRAWINGS

FIG. 1 is a schematic flowchart of a display method according to some embodiments of the present disclosure.

FIG. 2 is a schematic diagram of an image display according to some embodiments of the present disclosure.

FIG. 3 is a schematic diagram of another image display according to some embodiments of the present disclosure.

FIG. 4 is a schematic diagram of another image display according to some embodiments of the present disclosure.

FIG. 5 is a schematic diagram of another image display according to some embodiments of the present disclosure.

FIG. 6 is a schematic diagram of another image display according to some embodiments of the present disclosure.

FIG. 7 is a schematic structural diagram showing hardware composition of an electronic device according to some embodiments of the present disclosure.

### DETAILED DESCRIPTION OF THE EMBODIMENTS

The present disclosure is further described in detail in connection with the accompanying drawings and embodiments of the present disclosure.

Unless otherwise specified, the technologies and scientific terms used in the present disclosure are the same as the meaning generally understood by those skilled in the art. The terms used in the specification of the present disclosure are merely for describing embodiments of the present disclosure not for limiting the present disclosure.

With the development of related technologies, to meet user viewing needs, the screen sizes of electronic devices such as smartphones and tablets are gradually increasing. However, in the traditional display method, a content displayed on a screen at the same time is relatively monotonous. Meanwhile, the mismatching between a displayed image and a display area size causes a large portion of the display area of the display screen is not used, which leads to a waste of display resources.

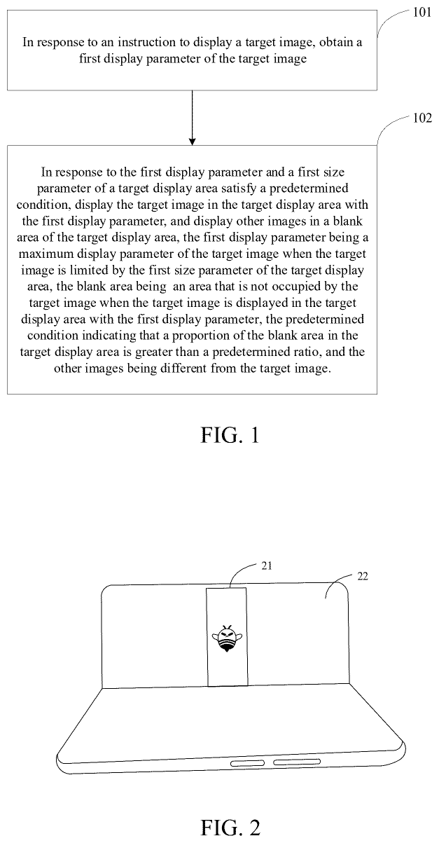

FIG. 1 is a schematic flowchart of a display method according to some embodiments of the present disclosure. As shown in FIG. 1, the method includes step 101 and step 102.

At 101, in response to an instruction for displaying a target image, a first display parameter of the target image is obtained.

In some embodiments, the instruction to display the target image can be issued by a user or by an application of the electronic device. The target image can be an image that needs to be displayed corresponding to the instruction for displaying the target image. The target image can include one image or a plurality of images. When the target image includes the plurality of images, the plurality of images can be combined as a display object. Exemplarily, the plurality of images can be rotated and spliced to be combined as a display object, which can be used as the target image. In some embodiments, after the target image is selected, the target image can be in a browsing state. In this state, the target image can serve as the main object viewed by the user. The whole target image may need to be displayed, and the target image may need to be displayed as large as possible to bring a good viewing experience for the user, i.e., displaying the target image fully and largely in the target area. Based on this, other images can be displayed in the blank area of the display area.

In some embodiments, the first display parameter of the target image can represent the display parameter when the target display image is displayed on the screen at the maximum size. The maximum size can refer to a maximum size that can be achieved when displaying the image without rotation, that is, a maximum size that can be achieved when the image is displayed in an original orientation of the image. For example, when a portrait image is displayed on a landscape-oriented phone screen, although the image can be displayed at a larger size with rotation, the normal viewing of the user can be affected. Thus, when the same image is displayed in different display areas of different size types, the image can be displayed at the maximum size without changing the original display orientation of the image. In some embodiments, the size parameter of the target display area can be a length 80 mm and a width 60 mm. The original size of the target image can be a length 50 mm and a width 40 mm. Thus, the first display parameter of the target image can be a length 75 mm and a width 60 mm. That is, the first display parameter can be the maximum display parameter without exceeding the display range of the target display area with the ratio of the target image unchanged. In some embodiments, the upper limit of the display parameter of the target display image can be limited by the width of the display area. Thus, the target image can be displayed on the target display area with a maximum display parameter of length 75 mm and width 60 mm.

At 102, if the first display parameter and the first size parameter of the target display area satisfy a predetermined condition, the target image is displayed in the target display area with the first display parameter, and other images are displayed in the blank area of the target display area.

The first display parameter is the maximum display parameter of the target image when the target image is limited by the first size parameter of the target display area. The blank area can be an area not taken by the target image when the target image is displayed in the target display area with the first display parameter. The predetermined condition can represent that the proportion of the blank area in the target display area is greater than a predetermined ratio. The other images can be different from the target image.

In some embodiments, the predetermined condition can include that a large portion of the blank area still exists after the target image is displayed on the display screen with the first parameter. The target display area can be the display area on the display screen. When the proportion of the blank area in the target display area is greater than the predetermined ratio, a large portion of the blank area may exist on the display screen. In some embodiments, the predetermined ratio can be 40% or other ratios. The value of the predetermined ratio can be set according to the actual application scenario or by the user.

In some embodiments, when the first display parameter and the first size parameter of the target display area satisfy the predetermined condition, the target image can be displayed in the target display area using the first display parameter, while other images can be displayed in the blank area of the target display area. In some embodiments, the first display parameter can be the maximum parameter at which the target image can be displayed in the target display area without exceeding the target display area and without changing the image ratio. The other images can be images stored in the electronic device different from the target image. In some embodiments, the other images can include one type of images or a plurality of types of images. The first size parameter can refer to the size of the target display area, i.e., parameters such as length, width, and area of the target display area. Thus, the target image can be displayed with the length, width, and area corresponding to the first display parameter.

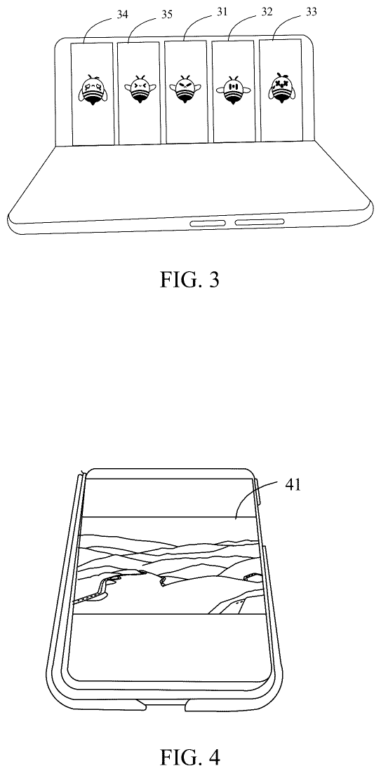

In some embodiments, the blank area in the target display area can refer to the area within the target display area that is not used for displaying the target image. FIG. 2 is a schematic diagram of an image display according to some embodiments of the present disclosure. As shown in FIG. 2, image 21 is the target image, and area 22 is the blank area. In a traditional display method, a large blank area exists on the display screen. FIG. 3 is a schematic diagram of another image display according to some embodiments of the present disclosure. Image 31 is the target image, and images 32, 33, 34, and 35 are other images. The blank area is used to display other images and improve the utilization of the display screen.

In embodiments of the present disclosure, in response to the instruction to display the target image, the first display parameter of the target image can be obtained. If the first display parameter and the size parameter of the target display area satisfy the predetermined condition, the target image can be displayed in the target display area at the first display parameter, and the other images can be displayed in the blank area of the target display area. The first display parameter can be the maximum display parameter of the target image when the target image is limited by the size parameter of the target display area. The blank area can be the area not occupied by the target image when the target image is displayed in the target area at the first display parameter. The predetermined condition can represent that the proportion of the blank area in the target display area is greater than the predetermined ratio. Other images can be different from the target image. By displaying the target image in the target display area at the maximum, and determining the proportion of the blank area, when the proportion of the blank area exceeds the predetermined ratio, other images can be filled and displayed in the blank area. To ensure that the image can be appropriately displayed, the display area of the screen can be sufficiently used to reduce the waste in the display resource and improve the user viewing experience.

In some embodiments, before displaying other images in the blank area of the target display area, the method can further include determining the second display parameter of other images based on the first display parameter and the first size parameter and displaying other images in the blank area of the target display area. Displaying the other images in the blank area of the target display area can include displaying the other images at the second display parameter in the blank area of the target display area.

In some embodiments, before displaying other images in the blank area, the second display parameter of the other images can be determined based on the first display parameter and the first size parameter of the target display area. In some embodiments, different target images can have different degrees of differences in image ratios. The corresponding first display parameters can also be different. The blank areas formed when the same target image is displayed in the target display areas of different sizes can also be different. Therefore, according to the first display parameter of the target image and the first size parameter of the target display area, the size parameter of the blank area can be determined. In some embodiments, the size and shape of the blank area can be determined according to the display position of the target image in the target display area set by the user or the system. Further, the other images can be determined to be displayed in the blank area with the second display parameter. Displaying the other images in the blank area with the second display parameter can include partially displaying the other images in the blank area, or displaying the whole other images in the blank area, which relies on which second display parameter is set.

Based on the above embodiments, based on the determined first display parameter of the target image and the size parameter of the target display area, which parameter that the other images are determined in the blank area can be determined. Thus, the layout of displaying the image in the target display area can be more appropriately arranged. Thus, the user can have a better viewing experience.

In some embodiments, the second display parameter can be the maximum display parameter when the other images are limited by the second size parameter of the blank area. In some other embodiments, the second display parameter can have a length the same as the length of the target display area in the first direction. The first direction can be the direction in which the length of the target image is the same as the length of the target display area.

In some embodiments, the second display parameter can be the maximum display parameter at which the other images can be displayed without exceeding the size parameter of the blank area. That is, the image ratio of the other images may not be changed, and the other images can be displayed in the blank area. The size parameter of the blank area can be the second size parameter.

In some embodiments, the second display parameter can also be the same as the length of the target display area in the first direction. The first direction can refer to the direction in which the target image and the target display area have the same side length. When the target image is displayed in the target display area with the first display parameter, one side of the target image can have the same length as the corresponding side of the display area. The direction where the side is can be the first direction. After determining the first direction, the other images can be displayed in the blank area with the second display parameter to cause the length of the other images to be the same as the length of the target display area in the first direction. In some embodiments, the other images can be rotated first to adapt to the view angle of the user. Then, the other images can be displayed with the second display parameter. The direction of the other images can be determined based on the direction after the rotation. When the other images are displayed in this method, the other images may only be partially displayed. However, the layout in the target display area may be relatively aligned, which is easy to view. When the user views the other images, the viewing effect can be similar to viewing a long image by scrolling. A single hand can slide the screen to view a plurality of images.

Based on the above, when different second display parameters are determined, the other images can be displayed in different display states, which can respectively meet the user needs for simultaneously viewing a plurality of images or scrolling through images. While the blank area of the display screen is fully utilized, the flexibility of the image display can be improved.

In some embodiments, the method can further include in response to an interactive operation of instructing to enlarge an image, displaying a partial area of the first image with a third display parameter in the target display area. The first image can be the target image or the other images instructed by the interactive operation.

In some embodiments, when the user needs to enlarge an image for viewing, the image can be enlarged and displayed in response to the interactive operation of instructing for enlarging the image. In some embodiments, the interactive operation for instructing to enlarge the image can be a general enlargement instruction. For example, the user can click an option to enlarge 2 times or 4 times to perform magnification enlargement. The interactive operation for enlarging the image can be a gesture instruction of the user. For example, two fingers of the user can select an area to perform enlargement. The enlargement magnification can change with the movement of the user fingers. In some other embodiments, the interactive operation can be the user double-clicking a certain part of the image to enlarge the image with the part as the center. Thus, the third display parameter can be determined according to the interactive operation for enlarging the image. For the general enlargement instruction, the image can be displayed with the display parameter to enlarge a part of the image 2 times or 4 times. For the gesture instruction, the magnification can change as the change in the user gesture.

In some embodiments, the first image can be an image selected by the interactive operation for enlarging the image or the target image by default, or an image selected by the user. When the first image is enlarged and displayed, the other part of the image except for the part being enlarged may no longer be displayed.

Based on the above, the image can be allowed to be enlarged and displayed. When a plurality of images exist in the target display area, some images can have relatively small display parameters when being displayed and can be inconvenient for viewing. By allowing the user to enlarge the image for viewing, the flexibility of the image display and the user operability can be enhanced. Thus, the user viewing experience can be improved.

In some embodiments, the aspect ratios of the other images can be the same as or different from the aspect ratio of the target image.

In some embodiments, the aspect ratio of an image can represent a size type of the image. For example, some images can be landscape-oriented (the horizontal length greater than the vertical length), and some images are portrait-oriented (the horizontal length smaller than the vertical length). Some images can be square (the horizontal length equal to the vertical length). When the other images are displayed in the blank area, images with the same or different aspect ratios as the target image can be selected for display. For instance, if the target image is landscape-oriented, the other images can be either landscape or portrait-oriented.

In some embodiments, the other images with the same aspect ratio as the aspect ratio of the blank area can be selected. For example, if the horizontal length of the blank area is greater than the vertical length, the landscape-oriented other images can be selected for display. In some other embodiments, the user can select the other images with a certain aspect ratio to be displayed in the blank area.

Based on the above, by selecting the other images with different aspect ratios to be displayed in the blank area, different layouts can be generated correspondingly to improve the flexibility of the image display. The plurality of layouts can adapt to different viewing habits of the user, which leads to a more versatile system.

In some embodiments, displaying the target image in the target display area with the first display parameter can include displaying the target image at the center of the target display area with the first display parameter.

In some embodiments, the center of the display area can be the geometric center of the target display area. Displaying the target image at the center of the target display area with the first display parameter can include determining the center of the target image, and causing the center of the target image to be close to the geometric center of the display area as much as possible to display the target image at the center of the target display area. FIG. 4 is a schematic diagram of another image display according to some embodiments of the present disclosure. As shown in FIG. 4, the image 41 is the target image. The image 41 is displayed at the center of the target display area.

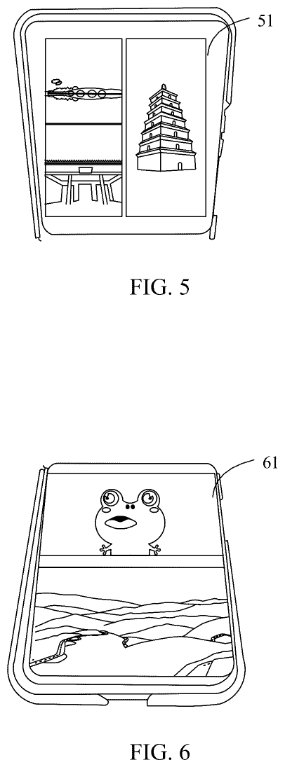

In some embodiments, the target image can also be displayed on the left, right, top, or bottom side of the target display area. For example, FIG. 5 is a schematic diagram of another image display according to some embodiments of the present disclosure. As shown in FIG. 5, the image 51 is the target image and is displayed close to the right side of the target display area, while other images are displayed on the left side of the target image. For another example, FIG. 6 is a schematic diagram of another image display according to some embodiments of the present disclosure. As shown in FIG. 6, the image 61 is the target image and displayed close to the upper side of the target display area, while other images are displayed below the target image.

In some embodiments, the camera of the electronic device can be configured to detect the viewing angle of the user. The target image can be adjusted to be at a position corresponding to the viewing angle of the user for display. Further, the display position of the target image can be continuously changed with the viewing angle of the user.

Based on the above, the target image can be displayed at different positions of the target display area. The display position of the target image can be adaptively adjusted when the user views the image from different viewing angles to obtain the optimal viewing experience.

In some embodiments, if the target display area can include the first display area and the second display area, the first target image can be displayed with the fourth display parameter in the first display area. The second target image can be displayed with the fifth display parameter in the second display area. The first other image can be displayed in the first blank area, and the second other image can be displayed in the second blank area.

The fourth display parameter can be the maximum display parameter of the first target image when the first target image is limited by the size parameter of the first display area. The fifth display parameter can be the maximum display parameter of the second target image when the second target image is limited by the size parameter of the second display area. The first blank area can be the area that is not occupied by the first target image when the first target image is displayed with the fourth display parameter in the first display area. The second blank area can be the area that is not occupied by the second target image when the second target image is displayed with the fifth display parameter in the second display area.

In some embodiments, the target display area can include a plurality of display areas. For example, for a foldable phone, the screen of the foldable phone can be folded to form a plurality of display areas. Taking two display areas as an example, the first target image can be displayed with the fourth display parameter in the first display area. The second target image can be displayed with the fifth display parameter in the second display area. The fourth display parameter can represent the maximum display parameter when the first target image does not exceed the size parameter of the first display area. The fifth display parameter can represent the maximum display parameter when the second target image does not exceed the size parameter of the second display area. The first target image and the second target image can be different images. The first display area and the second display area can have different size parameters.

In some embodiments, the first other image can be displayed in the blank area of the first display area, while the second other image can be displayed in the blank area of the second display area. The blank area of the first display area can be the area of the first display area except for the area displaying the first target image. The second blank area of the second display area can be the area of the second display area except for the area displaying the second target image. The first other image and the second other image can be images different from the first target image and the second target image.

In some embodiments, the user can adjust the images in the first display area and the second display area. In some embodiments, the user can exchange the positions of or arrange the images of the two display areas. For example, an image in the second display area can be exchanged with an image in the first display area. When an image is exchanged to another display area, a display parameter may need to be re-determined for display to adapt to the size parameter of the displayable area of the screen.

In some embodiments, when the target display area includes a plurality of display areas, an image can be displayed using the display method above for each display area.

Based on the above, when the target display area includes a plurality of display areas, images can be displayed in the plurality of display area, and the positions of the images can be freely swapped. When many images need to be viewed simultaneously, the target display area can be divided into a plurality of display areas to display more images.

In some embodiments, the method can further include, if the size parameter of the target display area is the third size parameter, determining the other image as the third other image, and if the size parameter of the target display area is the fourth size parameter, determining the other image as the fourth other image.

In some embodiments, when the size of the target display area changes, the quantity of the other images displayed in the blank area of the target display area can be different. For example, when the size parameter of the target display area changes from the third size parameter to the fourth size parameter, the other images displayed in the blank area of the target display area can change from the third other image to the fourth other image. The third other image and the fourth other image can be different images or differ in quantity.

In some embodiments, when the size parameter of the target display area decreases, and the quantity of the other images needs to be reduced, the user may be allowed to select the other images that need to be displayed, and the other images not selected by the user may not be displayed. When the size parameter of the target display area changes, the currently displayed target image may not be changed without receiving an instruction to change the target image.

Based on the above, when the size parameter of the target display area changes, the other images or the quantity of the other images can be dynamically adjusted to avoid excessive blank areas when the target display area increases or overly small display parameters with which the images cannot be viewed clearly when the target display area decreases.

In some embodiments, when the second display parameter includes a length equal to the side length of the target display area in the first direction, where the first direction is the direction in which the target image and the target display area have the same side length, displaying other images in the blank area of the target display area can include, if the size parameter of the target display area is the fifth size parameter, determining the other images displayed in the blank area as the first area of the other images, and if the size parameter of the target display area is the sixth size parameter, determining the other images displayed in the blank area as the second area of the other images.

In some embodiments, when the complete image content of the other images cannot be displayed in the blank area, the area displaying the other images can change with the size of the target display area. When the target image is ensured to be completely displayed, since the size parameter of the target display area changes, the size parameter of the blank area can change accordingly. For example, the fifth size parameter can be greater than the sixth size parameter. When the size parameter of the target display area changes from the fifth size parameter to the sixth size parameter, the size parameter of the corresponding blank area can be reduced. Thus, the area displaying the other images can be reduced, i.e., the first area is smaller than the second area.

In some embodiments, if the fifth size parameter is smaller than the sixth size parameter, when the size parameter of the target display area changes from the fifth size parameter to the sixth size parameter, the first area can be smaller than the second area.

Based on the above, when the size parameter of the target display area changes, the display range or area of the other images can be adjusted accordingly to cause the display parameters of the images to adapt to the changed target display area.

Embodiments of the present disclosure further provide a display apparatus. The apparatus can correspond to the display method. The steps of the method embodiments can be applicable to apparatus embodiments.

The apparatus can include an acquisition module, a display module, and a processing module.

The acquisition module can be configured to obtain the first display parameter of the target image in response to an instruction to display the target image.

If the first display parameter and the first size parameter of the target display area satisfy the predetermined condition, the display module can be configured to display the target image in the target display area with the first display parameter and to display the other images in the blank area of the target display area. The first display parameter can be the maximum display parameter of the target image when the target image is limited by the first size parameter of the target display area. The blank area can be the area that is not occupied by the target image when the target image is displayed in the target display area with the first display parameter. The predetermined condition can represent that the proportion of the blank area in the target display area is greater than the predetermined ratio. The other images can be different from the target image.

If the size parameter of the target display area is the third size parameter, the other image can be the third other image. If the size parameter of the target display area is the fourth size parameter, the other image can be the fourth other image.

The processing module can be configured to determine the second display parameter of the other image based on the first display parameter and the first size parameter.

The display module can be further configured to display the other image in the blank area of the target display area with the second display parameter. The second display parameter can be the maximum display parameter of the other image, when the other image is limited by the second size parameter of the blank area, or the second display parameter can have the same length as the side length of the target display area in the first direction. The first direction can be the direction in which the target image and the target display area have the same side length.

The aspect ratio of the other image can be the same as or different from the aspect ratio of the target image.

If the size parameter of the target display area is the fifth size parameter, the other image displayed in the blank area can be the first area of the other image.

If the size parameter of the target display area is the sixth size parameter, the other image displayed in the blank area can be the second area of the other image.

The display module can be further configured to, in response to an interactive operation indicating or enlarging the image, a partial area of the first image can be displayed in the target display area with the third display parameter. The first image can be the target image or the other image indicated by the interactive operation.

The display module can be further configured to display the target image in the center of the target display area with the first display parameter.

The display module can be further configured to, if the target display area includes a first display area and a second display area, display the first target image in the first display area with the fourth display parameter, display the second target image in the second display area with the fifth display parameter, display the first other image in the first blank area, and display the second other image in the second blank area.

The fourth display parameter can be the maximum display parameter of the first target image when the first target image is limited by the size parameter of the first display area. The fifth display parameter can be the maximum display parameter of the second target image when the second target image is limited by the size parameter of the second display area. The first blank area can be the area that is not occupied by the first target image when the first target image is displayed in the first display area with the fourth display parameter. The second blank area can be the area that is not occupied by the second target image when the second target image is displayed in the second display area with the fifth display parameter.

In practical applications, the acquisition module, the processing module, and the display module can be implemented by the processor of the display apparatus. Of course, the processor may need to execute the computer program in the storage device to realize the functions of the acquisition module, processing module, and display module.

The division of program modules can be described with examples when the apparatus of embodiments of the present disclosure is applied. In practical applications, the processing and assignment can be implemented by different program modules. That is, the internal structure of the apparatus can be divided into different program modules to implement the whole or partial processing. In addition, the display apparatus and display method embodiments of the present disclosure can belong to the same concept, which is not repeated here.

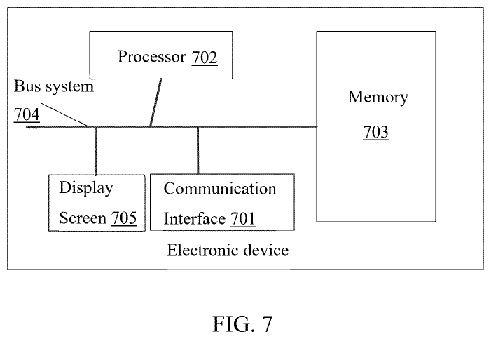

Based on the hardware implementation of the above program modules, to implement the method of embodiments of the present disclosure, embodiments of the present disclosure further provide an electronic device. FIG. 7 is a schematic structural diagram showing hardware composition of an electronic device according to some embodiments of the present disclosure. As shown in FIG. 7, the electronic device includes a display screen 705, a communication interface 701, and a processor 702.

The display screen 705 can be configured to display an image.

In some embodiments, the display screen can be bent and include a first body and a second body. The display screen can be attached to the first body and the second body. The relative position between the first body and the second body can be changed. When the first body and the second body are in a first posture, the display screen can be a flat surface. When the first body and the second body are in the second posture, at least a part of the display screen can be bent. The first body and the second body can be two members of the display screen. When the display screen is bent, the screen can be divided into two members, which can be used as the first body and the second body, respectively. In the first posture, the screen is not folded. In the second posture, the screen is folded.

The communication interface 701 can perform information interaction with another device such as a network device.

The processor 702 can be connected to the communication interface 701 to perform the information interaction with another device. When running the computer program, the processor 702 can be configured to execute the methods of one or more technical solutions. The computer program can be stored in the storage device 703. In some embodiments, the processor 702 can be configured to, in response to the instruction to display the target image, obtain the first display parameter of the target image, if the first display parameter and the first size parameter of the target display area satisfy the predetermined condition, display the target image in the target display area with the first display parameter, and display the other image in the blank area of the target display area. The first display parameter can be the maximum display parameter of the target image when the target image is limited by the first size parameter of the target display area. The blank area can be the area that is not occupied by the target image when the target image is displayed in the target display area with the first display parameter. The predetermined condition can indicate that the proportion of the blank area in the target display area is greater than the predetermined ratio. The other image can be different from the target image.

In practical applications, the assemblies of the electronic device can be coupled through the bus system 704. The bus system 704 can be used to realize the communication between the assemblies. The bus system can include a data bus, a power source bus, a control bus, and a state signal bus. To facilitate description, the buses in FIG. 7 can be referred to as a bus system 704.

The storage device 703 of embodiments of the present disclosure can be configured to store various types of data to support the operation of the computer device. For example, the data can include any computer program executed on the electronic device.

The storage device 703 can be volatile memory, non-volatile memory, or a combination thereof. The non-volatile memory can include Read-Only Memory (ROM), Programmable Read-Only Memory (PROM), Erasable Programmable Read-Only Memory (EPROM), Electrically Erasable Programmable Read-Only Memory (EEPROM), Ferromagnetic Random Access Memory (FRAM), Flash Memory, Magnetic surface storage, Optical discs, or Compact Disc Read-Only Memory (CD-ROM). The magnetic surface storage can include magnetic disk storage or magnetic tape storage. The volatile memory can include Random Access Memory (RAM) used as external high-speed cache. For example, the RAM can include but is not limited to Static Random Access Memory (SRAM), Synchronous Static Random Access Memory (SSRAM), Dynamic Random Access Memory (DRAM), Synchronous Dynamic Random Access Memory (SDRAM), Double Data Rate Synchronous Dynamic Random Access Memory (DDR SDRAM), Enhanced Synchronous Dynamic Random Access Memory (ESDRAM), SyncLink Dynamic Random Access Memory (SLDRAM), and Direct Rambus Random Access Memory (DRRAM). The memory described in embodiments of the present disclosure can be intended to include, but is not limited to, these and any other suitable types of memory.

The method of embodiments of the present disclosure can be applied to or implemented by a processor. The processor can be an integrated circuit chip with signal processing capability. During implementation, the steps of the above method can be completed through integrated logic circuits within the processor or in the form of software instructions. The processor can be a general-purpose processor, a DSP, or other programmable logic devices, discrete gates or transistor logic devices, discrete hardware assemblies, etc. The processor can be configured to implement or execute the methods, steps, and logic diagrams of embodiments of the present disclosure. A general-purpose processor can be a microprocessor or any conventional processor. The steps of the method of embodiments of the present disclosure can be directly executed by a hardware decoding processor or completed through a combination of hardware and software modules in the decoding processor. The software module can be stored in a storage medium. The storage medium can be located in memory. The processor can read the program from memory and complete the steps of the method in combination with the hardware of the decoding processor.

In some embodiments, when the processor 702 executes the program, the corresponding processes performed by the computer device of the methods of embodiments of the present disclosure are not repeated here for simplicity.

Embodiments of the present disclosure further provide a storage medium, i.e., a computer storage medium, which is a computer-readable storage medium. For example, the computer-readable storage medium can include a first memory storing a computer program. The computer program can be executed by the processor of the computer device to complete the steps of the method above. The computer-readable storage medium can include FRAM, ROM, PROM, EPROM, EEPROM, Flash Memory, magnetic surface storage, optical disks, CD-ROM, etc.

In embodiments of the present disclosure, the disclosed apparatuses, computer devices, and methods can be implemented in other methods. The device embodiments described above are merely illustrative. For example, the division of units can be merely a logical functional division. In practical applications, the units can be divided in other division methods. For example, the plurality of units or assemblies can be combined or integrated into another system, or some features can be ignored or not executed. In addition, the coupling, direct coupling, or communication connection between the displayed or discussed assemblies can be indirect coupling or communicative connection between devices or units through some interfaces and can be electrical, mechanical, etc.

The units described as separate parts above may or may not be physically separated. The parts displayed as units may or may not be physical units. The parts can be located in one place or distributed across a plurality of network units. Some or all units can be selected according to actual needs to achieve the objectives of embodiments of the present disclosure.

In addition, in embodiments of the present disclosure, the functional units can all be integrated into one processing unit, the units can be used as individual units, or two or more units can be integrated into one unit. The integrated unit can be implemented by hardware or a combination of the hardware and software.

Those skilled in the art can understand that all or some steps of the method of embodiments of the present disclosure can be implemented through the program instructing the related hardware. The above program can be stored in the computer-readable storage medium. When the program is executed, the steps of the method embodiments can be executed. The storage medium can include mobile storage devices, ROM, RAM, magnetic disks, optical disks, and other media capable of storing program codes.

Alternatively, if the integrated unit of the present disclosure is implemented as a software functional module and sold or used as an independent product, the integrated unit can also be stored in a computer-readable storage medium. Based on this understanding, the technical solution of the present disclosure, in essence, or at least the part contributing to the related technology, can be embodied as a software product. The computer software product can be stored in a storage medium and include a plurality of instructions to enable a computer device (e.g., a personal computer, server, network device, etc.) to execute all or some of the methods described in the embodiments of the present disclosure. The storage medium can include mobile storage devices, ROM, RAM, magnetic disks, optical disks, and other media capable of storing program codes.

Embodiments of the present disclosure further provide a computer program product, including a computer program. The computer program can be executed by the processor 702 of the electronic device to complete the steps of the display method of the present disclosure.

The terms “first,” “second,” etc., can be used to distinguish similar objects and do not necessarily indicate a specific sequence or order.

Additionally, the technical solutions of embodiments of the present disclosure can be arbitrarily grouped when there is no conflict.

The above are merely some embodiments of the present disclosure. However, the scope of the present disclosure is not limited to this. Those skilled in the art can easily think of modifications or replacements within the technical scope of the present disclosure. These modifications and replacements should be within the scope of the present disclosure. The scope of the present disclosure should conform to the scope of the claims.

What is claimed is:

1. A display method comprising:
in response to an instruction to display a target image, obtaining a first display parameter of the target image; and
in response to the first display parameter and a first size parameter of a target display area satisfying a predetermined condition, displaying the target image in the target display area with the first display parameter, and displaying other images in a blank area of the target display area;
wherein:
the first display parameter is a maximum display parameter of the target image when the target image is limited by the first size parameter of the target display area;
the blank area is an area that is not occupied by the target image when the target image is displayed in the target display area with the first display parameter;
the predetermined condition indicates that a proportion of the blank area in the target display area is greater than a predetermined ratio; and
the other images are different from the target image.

2. The method according to claim 1, further comprising, before displaying the other images in the blank area of the target display area:
determining a second display parameter of the other images based on the first display parameter and the first size parameter;
wherein displaying the other images in the blank area of the target display area includes displaying the other images in the blank area of the target display area with the second display parameter.

3. The method according to claim 2, wherein:
the second display parameter is a maximum display parameter of the other images when the other images are limited by a second size parameter of the blank area; or
the second display parameter has a same side length as a side length of the target display area in a first direction, and the first direction is a direction in which the target image and the target display area have a same side length.

4. The method according to claim 3, further comprising:
in response to an interactive operation indicating image enlargement, displaying a partial area of a first image in the target display area with a third display parameter;
wherein the first image is the target image or the other image indicated by the interactive operation.

5. The method according to claim 2, wherein:
an aspect ratio of the other images is the same as or different from an aspect ratio of the target image.

6. The method according to claim 1, wherein displaying the target image in the target display area with the first display parameter includes:
displaying the target image in a center of the target display area with the first display parameter.

7. The method according to claim 1, further comprising:
in response to the target display area including a first display area and a second display area, displaying a first target image in the first display area with a fourth display parameter, displaying a second target image in the second display area with a fifth display parameter, displaying a first other image in a first blank area, and displaying a second other image in a second blank area;
wherein:
the fourth display parameter is a maximum display parameter of the first target image when the first target image is limited by a size parameter of the first display area;
the fifth display parameter is a maximum display parameter of the second target image when the second target image is limited by a size parameter of the second display area;
the first blank area is an area not occupied by the first target image when the first target image is displayed in the first display area with the fourth display parameter; and
the second blank area is an area not occupied by the second target image when the second target image is displayed in the second display area with the fifth display parameter.

8. The method according to claim 1, further comprising:
in response to the size parameter of the target display area being a third size parameter, determining the other image as a third other image; and
in response to the size parameter of the target display area being a fourth size parameter, determining the other image as a fourth other image.

9. The method according to claim 3, wherein the second display parameter has a side length the same as the side length of the target display area in the first direction, the first direction is a direction in which the target image has a side length the same as the side length of the target display area, and displaying the other image in the blank area of the target display area includes:
in response to the size parameter of the target display area being a fifth size parameter, determining the other image displayed in the blank area as a first area of the other image; and
in response to the size parameter of the target display area being a sixth size parameter, determining the other image displayed in the blank area as a second area of the other image.

10. An electronic device comprising:
a display screen configured to display an image
one or more processors, and
one or more memories storing a computer program that, when executed by the one or more processors, causes the one or more processors to:
in response to an instruction to display a target image, obtain a first display parameter of the target image; and
in response to the first display parameter and a first size parameter of a target display area satisfy a predetermined condition, display the target image in the target display area with the first display parameter, and display other images in a blank area of the target display area;
wherein:
the first display parameter is a maximum display parameter of the target image when the target image is limited by the first size parameter of the target display area;
the blank area is an area that is not occupied by the target image when the target image is displayed in the target display area with the first display parameter;
the predetermined condition indicates that a proportion of the blank area in the target display area is greater than a predetermined ratio; and
the other images are different from the target image.

11. The device according to claim 10, wherein the one or more processors are further configured to:
determine a second display parameter of the other images based on the first display parameter and the first size parameter; and
display the other images in the blank area of the target display area with the second display parameter.

12. The device according to claim 11, wherein:
the second display parameter is a maximum display parameter of the other images when the other images are limited by a second size parameter of the blank area; or
the second display parameter has a same side length as a side length of the target display area in a first direction, and the first direction is a direction in which the target image and the target display area have a same side length.

13. The device according to claim 12, wherein the one or more processors are further configured to:
in response to an interactive operation indicating image enlargement, display a partial area of a first image in the target display area with a third display parameter;
wherein the first image is the target image or the other image indicated by the interactive operation.

14. The device according to claim 11, wherein:
an aspect ratio of the other images is the same as or different from an aspect ratio of the target image.

15. The device according to claim 10, wherein the one or more processors are further configured to:
display the target image in a center of the target display area with the first display parameter.

16. The device according to claim 1, wherein the one or more processors are further configured to:
in response to the target display area including a first display area and a second display area, display a first target image in the first display area with a fourth display parameter, display a second target image in the second display area with a fifth display parameter, display a first other image in a first blank area, and display a second other image in a second blank area;
wherein:
the fourth display parameter is a maximum display parameter of the first target image when the first target image is limited by a size parameter of the first display area;
the fifth display parameter is a maximum display parameter of the second target image when the second target image is limited by a size parameter of the second display area;
the first blank area is an area not occupied by the first target image when the first target image is displayed in the first display area with the fourth display parameter; and
the second blank area is an area not occupied by the second target image when the second target image is displayed in the second display area with the fifth display parameter.

17. The device according to claim 10, wherein the one or more processors are further configured to:
in response to the size parameter of the target display area being a third size parameter, determine the other image as a third other image; and
in response to the size parameter of the target display area being a fourth size parameter, determine the other image as a fourth other image.

18. The device according to claim 12, wherein the second display parameter has a side length the same as the side length of the target display area in the first direction, the first direction is a direction in which the target image has a side length the same as the side length of the target display area, and the one or more processors are further configured to:
in response to the size parameter of the target display area being a fifth size parameter, determine the other image displayed in the blank area as a first area of the other image; and
in response to the size parameter of the target display area being a sixth size parameter, determine the other image displayed in the blank area as a second area of the other image.
